(19) United States
(12) Patent Application Publication
(10) Pub. No.: US 2008/0129726 A1
(43) Pub. Date: Jun. 5, 2008

(54) SILHOUETTE RENDERING APPARATUS AND METHOD USING 3D TEMPORAL COHERENCE FOR RIGID OBJECT

(76) Inventors: Hee Jeong KIM, Daejeon (KR); Bo Youn KIM, Daejeon (KR); Bon Ki KOO, Daejeon (KR); Ji Hyung LEE, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/944,809

(22) Filed: Nov. 26, 2007

(30) Foreign Application Priority Data
Dec. 4, 2006 (KR) 10-2006-0121536
Sep. 17, 2007 (KR) 10-2007-0094264

(51) Int. Cl. G06T 15/00; G06T 17/00

(52) U.S. Cl. 345/419; 345/420; 382/190; 345/441

(57) ABSTRACT

Provided is a silhouette rendering apparatus and method using temporal coherence in a 3D space. The silhouette rendering apparatus includes: an edge extracting module for extracting edges of a 3D object by using a smooth surface method generating edges on a surface among silhouette extracting algorithms among mesh information representing a mesh shape; a stroke generating module for generating a stroke by linking the acquired edges; and a parameter computing module for determining a related stroke based on camera and object animation information extracted from current and previous frames of the stroke, computing style-related parameters of the stroke, and setting them up. This makes artists freely express silhouette by applying parameters of silhouette edges to a silhouette style having temporal coherence between frames based on a concept that the silhouette edges move in a 3D space. Also, the present invention resolves a problem of temporal coherence of a silhouette rendering style which effectively reflects the shape of a 3D object.

### BACKGROUND OF THE INVENTION

1. Field of the Invention

The present invention relates to a silhouette rendering apparatus and method using temporal coherence in three-dimensional (3D) space, and more particularly, to a silhouette rendering apparatus and method for smoothening silhouette in a 3D space by setting up parameters such as offset and texture coordinates and maintaining temporal coherence of a style.

This work was supported by the Information Technology (IT) research and development program of the Korean Ministry of Information and Communication (MIC) and/or the Korean Institute for Information Technology Advancement (IITA) [2005-S-082-02, “Development of Non-Photorealistic Animation Technology”].

2. Description of the Related Art

Silhouette rendering of a 3D object, which shows an object effectively and simply, is not only useful but also significant in the field of non-realistic rendering because silhouette rendering is the basic feature of all pictures. Among featuring lines expressing objects, silhouette, which forms boundary between an object and a background and an object and another object, constantly changes according to a view point. This makes it hard to control the style. Silhouette takes a significant part in expressing a 3D shape in the field of non-realistic animation.

Silhouette extraction algorithms include an algorithm of determining whether a shared edge is silhouette based on normal of an adjacent surface searched out in an object space and a smooth silhouette extraction algorithm of extracting silhouette smoothly moving on a surface.

U.S. Pat. No. 7,113,191 entitled “Rendering a Silhouette Edge” and filed by Intel Corporate et al., discloses a technology for rending edges of silhouette reflecting geometrical information of a 3D object by collecting geometrical information of the 3D model and determining a display format based on the geometrical information. However, the technology has a shortcoming that the silhouette is fixed or the edges of the silhouette blur due to slow temporal tracing.

Also, when a line is rendered in the non-realistic rending field, silhouette is regenerated according to animation of an object whenever a view point is changed. When each of the edges is acquired separately for the silhouette and a line connecting the edges is called a stroke, the number of edges that form a stroke and/or the number of strokes are different for each frame.

The offset of a line is changed or texture mapping is used to give a stroke a manually drawn effect in the non-realistic rendering field, but a continuously smooth image cannot be acquired because the silhouette changes in every frame. To smoothly show silhouette in animation, temporal coherence of the style should be maintained. Therefore, it is required to develop an apparatus for setting up parameters such as offset and texture coordinates to maintain the temporal coherence.

### SUMMARY OF THE INVENTION

Accordingly, the present invention is directed to a silhouette rendering apparatus, which substantially obviates one or more problems due to limitations and disadvantages of the related art.

It is an object of the present invention to provide a silhouette rendering apparatus and method which can maintain temporal coherence of a silhouette style in animation and make the silhouette form animation.

It is another object of the present invention to provide a silhouette rendering apparatus and method which sets up parameters such as offset and texture coordinates to maintain temporal coherence of a silhouette style and smoothly show the silhouette during animation in non-realistic rendering.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a silhouette rendering apparatus using temporal coherence in a 3D space, which includes: an edge extracting module for extracting edges of a 3D object by using a smooth surface method which generates edges on a surface among algorithms for extracting silhouette among mesh information representing a mesh shape; a stroke generating module for generating a stroke by linking the edges acquired in the edge extracting module; and a parameter computing module for determining a related stroke based on camera animation information and object animation information that are extracted from a current frame and a previous frame of the stroke in the stroke generating module, computing style-related parameters of the stroke, and setting up the parameters.

In another aspect of the present invention, there is provided a silhouette rendering method, which includes the steps of: extracting edges and silhouette from a 3D mesh by using a smooth surface algorithm; linking the extracted silhouette to a stroke, applying the extracted silhouette to animation of an object, and setting up parameters related to a style in the linked stroke; generating a stroke for a next frame by extracting and linking edges for the next frame; setting up parameters related to a style by determining a related stroke based on camera animation information and object animation information in a current frame and a previous frame that are set up in the step of setting up parameters related to a style in the linked stroke; and rendering the silhouette by using the parameters set up in the step of setting up parameters related to a style in the linked stroke and the step of setting up parameters related to a style by determining a related stroke based on camera animation information and object animation information in a current frame and a previous frame.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 is a block view illustrating a silhouette rendering apparatus using temporal coherence in a 3D space in accordance with an embodiment of the present invention;

FIG. 2 is a flowchart describing a silhouette rendering method using temporal coherence in a 3D space in accordance with an embodiment of the present invention;

FIG. 3 is a flowchart showing a process of finding a peak related to a previous frame to determine parameters of silhouette peaks according to the method of FIG. 2;

FIGS. 4A to 4D illustrate a 3D object to be inputted and transformed into a 3D mesh, a shape acquired by extracting silhouette edges from the 3D mesh, texture used to express the style, and silhouette expressing the style using the texture, respectively, according to an embodiment of the present invention; and

FIG. 5A and FIG. 5B show silhouette edges acquired through linear interpolation and a shape forming a stroke in accordance with an embodiment of the present invention.

### DETAILED DESCRIPTION OF THE INVENTION

Reference will now be made in detail to the preferred embodiments of the present invention, examples of which are illustrated in the accompanying drawings.

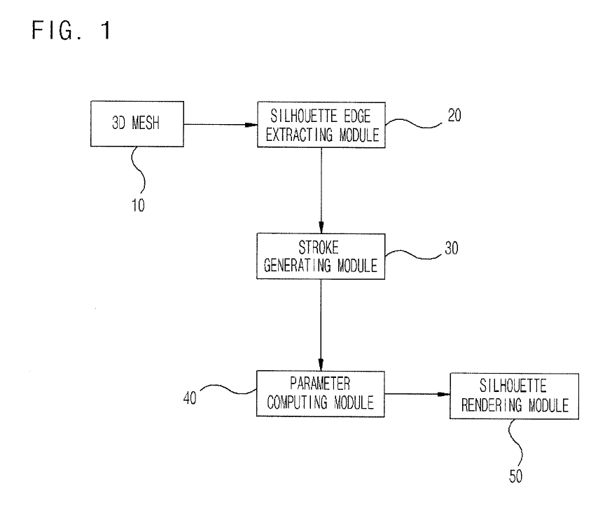

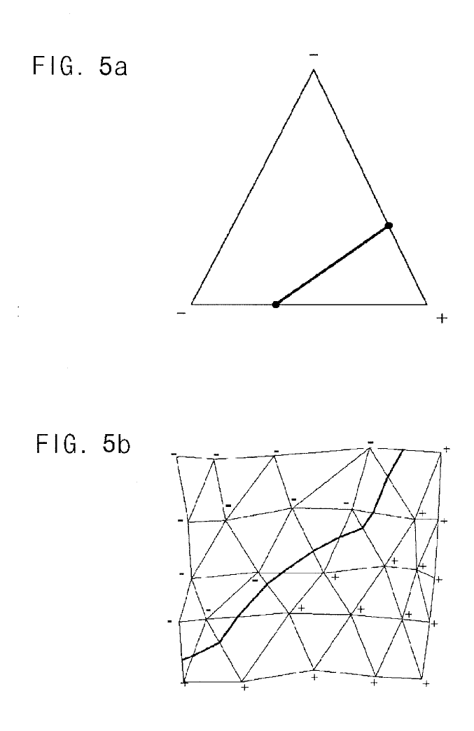

FIG. 1 is a block view illustrating a silhouette rendering apparatus using temporal coherence in a 3D space in accordance with an embodiment of the present invention. FIG. 5A and FIG. 5B show silhouette edges acquired through linear interpolation and a shape forming a stroke in accordance with an embodiment of the present invention.

Referring to FIG. 1 and FIG. 5A and FIG. 5B, the silhouette rendering apparatus of the present invention includes a 3D mesh 10, a silhouette edge extracting module 20, a stroke generating module 30, a parameter computing module 40, and a silhouette rendering module 50.

First, the 3D mesh 10 is mesh information representing a mesh shape with coordinates value based on information processed by a camera or data produced by a graphic designer.

The silhouette edge extracting module 20 extracts edges of a 3D object by using a smooth surface method which generates edges on a surface among algorithms for extracting silhouette among 3D meshes. Herein, the smooth surface method is a method of newly generating and extracting edges on a surface where silhouette can be formed. Silhouette is extracted by linking surface information of a previous 3D mesh and the extracted edges with neighboring information of each surface, and setting up parameters related to a style based on animation information of an object or camera.

Herein, FIG. 5A shows silhouette edges acquired by computing an inner product of camera direction and normal at three peaks to find silhouette edges on a surface and performing linear interpolation at each edge, and FIG. 5B shows a shape forming silhouette stroke by linking the silhouette edges.

The stroke generating module 30 generates a stroke by linking the edges acquired in the edge extracting module 20. The stroke generating module 30 also extracts edges and generates a stroke for the next frame.

Silhouette is linked using surface information of a surface neighboring a surface including the silhouette edges acquired before. Strokes formed by linking the silhouette edges include strokes forming a circle and strokes not forming a circle.

The parameter computing module 40 determines a related stroke based on animation information of an object and camera extracted from the current frame of the generated stroke and a previous frame, computes style-related parameters of the stroke, and sets up the parameters.

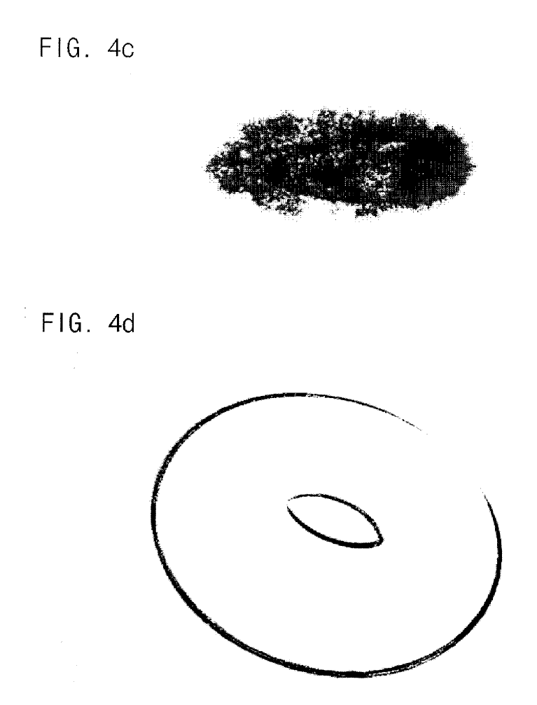

Computing and setting up the parameters of edges included in each stroke signify that a manual drawing effect can be expressed by computing, changing and setting up the start and end of texture coordinates and offsets in the middle of drawing. The expressed result will be described below with reference to FIGS. 4A to 4D.

FIGS. 4A to 4D illustrate a 3D object to be inputted and transformed into a 3D mesh, a shape acquired by extracting silhouette edges from the 3D mesh, texture used to express the style, and silhouette expressing the style using the texture, respectively, according to an embodiment of the present invention.

The silhouette rendering module 50 shown in FIG. 1 directly extracts animation information of silhouette from animation information of an object and a camera and performs rendering using parameters related to a stroke to maintain temporal coherence of the silhouette.

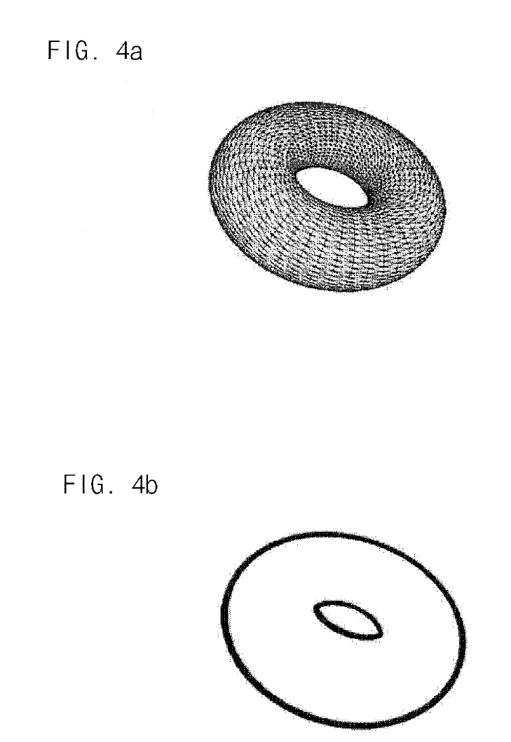

When silhouette extracted using a smooth surface algorithm is rendered using the parameters, a silhouette stroke may disappear while moving, be divided into two, or be newly generated according to a change in a view point, that is, animation of a camera or an object. Thus, silhouette appears moving on the surface of the object as the camera or the object moves. This will be described below in detail with reference to FIG. 3.

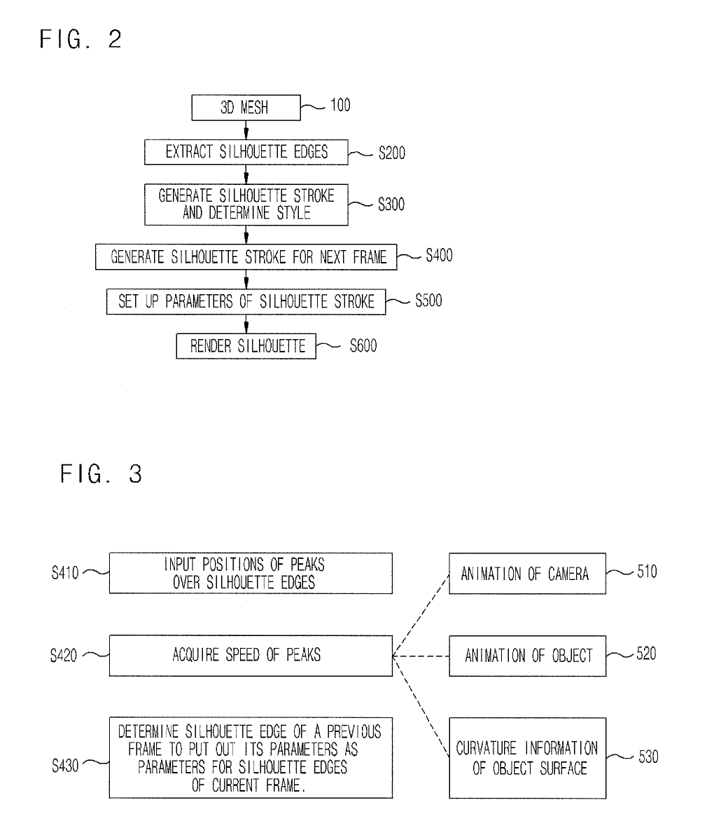

FIG. 2 is a flowchart describing a silhouette rendering method using temporal coherence in a 3D space in accordance with an embodiment of the present invention.

Referring to FIG. 2, at step S200, the silhouette edge extracting module 20 extracts edges and silhouette from the 3D mesh 100 by using a smooth surface method.

The extracted silhouette is linked to a stroke and applied to animation of an object. Silhouette is regenerated whenever a view point is changed.

At step S300, parameters related to a style are set up in the linked stroke.

At step S400, the silhouette edge extracting module 20 extracts edges for the next frame and generates a stroke by linking the edges.

At step S500, style-related parameters are set up by determining a related stroke based on the animation information of the camera and the object in the current frame set up at the step S400 and the previous frame set up at the step S300.

At step S600, silhouette is rendered using the parameters.

FIG. 3 is a flowchart showing a process of finding a peak related to a previous frame to determine parameters of silhouette peaks according to the method of FIG. 2.

Referring to FIG. 3, first, silhouette is generated according to position of a camera and motion of an object. Thus, silhouette motion route can be traced using animation information 510 of the camera and animation information 520 of the object.

Peaks over silhouette edges extracted based on the smooth surface algorithm slowly move from one surface to a neighboring surface when the camera or the object slowly moves.

Herein, when the positions of the peaks over the silhouette edges are given by an input device such as camera at step S410, the speed of each peak can be approximated from curvature information 530 of the object, speed of a surface with edges of the object animation 520, and the camera speed 510. Thus, the speed of the peaks over the silhouette edges is acquired at step S420.

At step S430, a silhouette edge of a previous frame to put out its parameters as parameters for silhouette edges of the current frame is determined based on the speed of the peaks over the silhouette edges acquired at the step S420.

When edges are linked to form a stroke, the number of edges included in the stroke may change according to the shape of the object. Thus, the parameters are set up based on a change in scale of the parameter variance. Through the process, silhouette edges do not dis

appear and are regenerated but they are shown animated.

The method of the present invention may be realized as a program and stored in computer-readable recording media, such as CD-ROM, RAM, ROM, floppy disks, hard disks, magneto-optical disks and the like. Since this process can be easily implemented by those of ordinary skill in the art of the present invention, detailed description will not be provided herein.

When a meandering effect is given to show a manually drawn effect or a style is given through texture map in a non-realistic animation field, temporal coherence is the most critical matter. The present invention, however, makes artists freely express silhouette by applying parameters of silhouette edges to a style of silhouette having temporal coherence between frames based on a concept that the silhouette edges move in a 3D space. Also, the present invention resolves a problem of temporal coherence of a silhouette rendering style which effectively reflects the shape of a 3D object.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. An apparatus for rendering silhouette by using temporal coherence in a 3D space, comprising:
an edge extracting module for extracting edges of a 3D object by using a smooth surface method which generates edges on a surface among algorithms for extracting silhouette among mesh information representing a mesh shape;
a stroke generating module for generating a stroke by linking the edges acquired in the edge extracting module; and
a parameter computing module for determining a related stroke based on camera animation information and object animation information that are extracted from a current frame and a previous frame of the stroke in the stroke generating module, computing style-related parameters of the stroke, and setting up the parameters.

2. The apparatus of claim 1, further comprising:
a silhouette rendering module for rendering the silhouette by directly extracting silhouette animation information from the camera animation information and the object animation information and using the parameters related to the stroke to maintain temporal coherence of silhouette.

3. The apparatus of claim 1, wherein the smooth surface method includes the steps of:
newly generating and extracting edges on a surface where silhouette can be formed;
extracting silhouette by linking surface information of a previous 3D mesh and the extracted edges with neighboring information of each surface, and setting up parameters related to a style based on the camera animation information and the object animation information.

4. The apparatus of claim 1, wherein computing and setting up the parameters of the edges included in the stroke computing module are computing and changing start and end of texture coordinates and offset in the middle.

5. A method for rendering silhouette by using temporal coherence in a 3D space, comprising the steps of:
extracting edges and silhouette from a 3D mesh by using a smooth surface algorithm;
linking the extracted silhouette to a stroke, applying the extracted silhouette to animation of an object, and setting up parameters related to a style in the linked stroke;
generating a stroke for a next frame by extracting and linking edges for the next frame;
setting up parameters related to a style by determining a related stroke based on camera animation information and object animation information in a current frame and a previous frame that are set up in the step of setting up parameters related to a style in the linked stroke; and
rendering the silhouette by using the parameters set up in the step of setting up parameters related to a style in the linked stroke and the step of setting up parameters related to a style by determining a related stroke based on camera animation information and object animation information in a current frame and a previous frame.

6. The method of claim 5, wherein the step of setting up parameters related to a style in the linked stroke and the step of setting up parameters related to a style by determining a related stroke based on camera animation information and object animation information in a current frame and a previous frame includes the steps of:
when positions of peaks over silhouette edges are given by an input device, computing speed of the peaks over silhouette edges based on curvature information of the object, speed of surface with edges of object animation, and speed of the input device; and
determining a silhouette edge of the previous frame to put out parameters as parameters for silhouette edges of the current frame based on the acquired speed of peaks over the silhouette edges.

7. The method of claim 5, wherein the parameters are set up based on a change in scale of the parameter variance.

8. A computer-readable recording medium for storing a program implementing a method, comprising the steps of:
extracting edges and silhouette from a 3D mesh by using a smooth surface algorithm;
linking the extracted silhouette to a stroke, applying the extracted silhouette to animation of an object, and setting up parameters related to a style in the linked stroke;
generating a stroke for a next frame by extracting and linking edges for the next frame;
setting up parameters related to a style by determining a related stroke based on camera animation information and object animation information in a current frame and a previous frame that are set up in the step of setting up parameters related to a style in the linked stroke; and
rendering the silhouette by using the parameters set up in the step of setting up parameters related to a style in the linked stroke and the step of setting up parameters related to a style by determining a related stroke based on camera animation information and object animation information in a current frame and a previous frame.
